(19) United States
(12) Patent Application Publication
(10) Pub. No.: US 2024/0347789 A1
(43) Pub. Date: Oct. 17, 2024

(54) BATTERY SYSTEM

(71) Applicant: TOYOTA JIDOSHA KABUSHIKI KAISHA, Toyota-shi (JP)

(72) Inventors: Mitsutoshi OTAKI, Susono-shi (JP); Shinji NAKANISHI, Mishima-shi (JP); Tetsuya WASEDA, Susono-shi (JP); Jun YOSHIDA, Mishima-shi (JP); Tsubasa MIGITA, Osaka (JP); Yoshihiro UCHIDA, Nagakute-shi (JP)

(73) Assignee: TOYOTA JIDOSHA KABUSHIKI KAISHA, Toyota-shi (JP)

(21) Appl. No.: 18/425,262

(22) Filed: Jan. 29, 2024

(30) Foreign Application Priority Data
Apr. 12, 2023 (JP) 2023-064779

(51) Int. Cl. H01M 10/42; H01M 4/02; H01M 4/38; H01M 10/0562; H01M 10/44

(52) U.S. Cl. CPC H01M 10/425; H01M 4/386; H01M 10/0562; H01M 10/44; H01M 2004/028; H01M 2010/4271; H01M 2300/0068

(57) ABSTRACT

A battery system includes a control device. The control device is configured to perform a first control and a second control. The first control includes placing an all-solid-state battery in an over-discharge state. The second control includes pressurizing the all-solid-state battery in the over-discharge state. The all-solid-state battery includes an anode layer, a solid electrolyte layer, and a cathode layer, in this order. The cathode layer includes silicon grains. The silicon grains include a clathrate II crystalline phase.

### CROSS-REFERENCE TO RELATED APPLICATION

This application claims priority to Japanese Patent Application No. 2023-064779 filed on Apr. 12, 2023, incorporated herein by reference in its entirety.

### BACKGROUND

### 1. Technical Field

The present disclosure relates to a battery system.

### 2. Description of Related Art

Japanese Unexamined Patent Application Publication No. 2019-145247 (JP 2019-145247 A) discloses a high-restraint processing of a solid-state secondary battery.

### SUMMARY

Silicon (Si) grains have been studied as cathode active materials for all-solid-state batteries. Si grains have a large specific capacitance. On the other hand, the silicon grains tend to have a very large coefficient of expansion during charging. Change in volume due to charging and discharging is large, and accordingly there is a possibility that cracking will occur in the Si grains due to repetitive charging and discharging. Cracks in Si grains can lead to partial loss of electric contact and ionic contact in an electrode (cathode layer). It is thought that battery resistance will increase as a result. Hereinafter, “electrical contact and ionic contact” may be collectively referred to as “contacts”.

In an all-solid-state battery, an electrolyte that is solid is used. That is to say, the electrolyte does not have fluidity. Accordingly, it is thought that the lost contacts will not readily recover naturally. To this end, a proposal has been made to restore the contacts by pressurizing the all-solid-state battery, for example (see JP 2019-145247 A, for example).

The cathode layer may have reactive spots. That is to say, there may be variance in the state of charge (SOC) of individual Si grains in the cathode layer. As described above, Si grains tend to have a very high coefficient of expansion during charging. A small difference in the SOC between two Si grains can result in a large volume difference. In other words, there may be large variations in the sizes of individual Si grains at any state of charge. In a state in which the variations in grain size are large, there is a possibility that recovery of the contacts will not readily be brought about even when the cathode layer is compressed.

It is an object of the present disclosure to recover contacts in a cathode layer.

Hereinafter, technical configurations, and operations and effects of the present disclosure will be described. Note however, that an acting mechanism according to the present specification includes estimation. The acting mechanism does not limit the technical scope of the present disclosure.

1.

In one aspect of the present disclosure, a battery system includes the following configuration. A battery system includes a control device. The control device is configured to perform a first control and a second control. The first control includes placing an all-solid-state battery in an over-discharge state. The second control includes pressurizing the all-solid-state battery in the over-discharge state. The all-solid-state battery includes an anode layer, a solid electrolyte layer, and a cathode layer, in this order. The cathode layer includes silicon grains. The silicon grains include a clathrate II crystalline phase.

Typically, Si grains include a diamond-type crystalline phase. In contrast, the Si grains according to the present disclosure include a clathrate II crystalline phase. The clathrate II crystalline phase exhibits an expansion behavior that is distinct from the diamond-type crystalline phase.

FIG. 1 is a graph illustrating examples of expansion behaviors of Si grains. The horizontal axis of the graph represents the SOC. The vertical axis of the graph represents the coefficient of expansion. The coefficient of expansion is obtained by the following Expression.

α=(v−v₀)/v₀
α: coefficient of expansion (values expressed as percentages).
v: Volume of Si grains at any SOC
v₀: Volume of Si grains at 0% SOC

The diamond-type crystalline phase can expand rapidly under increase in the SOC. In the diamond-type crystalline phase, a rapid expansion can be observed in the entire area where the SOC exceeds 0%. It is thought that when Si grains include the diamond-type crystalline phase, reactive spots can cause large variations in the size of Si grains.

In contrast, the clathrate II crystalline phase has a very gradual volume change at a SOC of 0% to 30%. Volume change may not substantially occur. It is anticipated that the size variations of Si grains will be significantly reduced in a SOC of 0% to 30% when the Si grains contain the clathrate II crystalline phase.

Generally, when Si grains (cathode active material) have a SOC of 0% to 30%, the all-solid-state battery is in an over-discharge state. Thus, the first control includes placing the all-solid-state battery in an over-discharge state. When the all-solid-state battery is in an over-discharge state, variations in the size of Si grains in the cathode layers can be significantly reduced. The second control includes pressurizing the all-solid-state battery in the over-discharge state. It is anticipated that compressing the cathode layers in a state in which the Si grains are uniformly sized will promote restoration of the contacts.

2.

The battery system according to the above “1” may include, for example, the following configuration. In the over-discharge state, the silicon grains are in a state of charge of 0% to 30%.

3.

The battery system according to the above “1” or “2” may include, for example, the following configuration. The first control further includes performing at least one of constant voltage discharging and constant voltage charging of the all-solid-state battery in the over-discharge state.

It is anticipated that the SOC of the individual Si grains will be homogenized by maintaining a constant inter-terminal voltage in the over-discharge state. That is to say, it is anticipated that variations in the size of Si grains will be further reduced.

4.

The all-solid-state battery according to any one of items “1” to “3” may include, for example, the following configuration. The cathode layer further includes a sulfide solid electrolyte.

Sulfide solid electrolytes tend to have high formability. It is anticipated that recovery of the contacts will be promoted during pressurization, due to the cathode layer containing the sulfide solid electrolyte.

5.

In one aspect of the present disclosure, a battery system includes the following configuration. A battery system includes a control device. The control device is configured to perform a first control and a second control. The first control includes placing an all-solid-state battery in an over-discharge state. The first control further includes performing at least one of constant voltage discharging and constant voltage charging of the all-solid-state battery in the over-discharge state. The second control includes pressurizing the all-solid-state battery in the over-discharge state. The all-solid-state battery includes an anode layer, a solid electrolyte layer, and a cathode layer, in this order. The cathode layer includes silicon grains and a sulfide solid electrolyte. The silicon grains include a clathrate II crystalline phase. In the over-discharge state, the silicon grains are in a state of charge of 0% to 30%.

An embodiment of the present disclosure (hereinafter, may be abbreviated to “present embodiment”) will be described below. Note however, that the present embodiment does not limit the technical scope of the present disclosure. The present embodiment is exemplary in all respects. This present embodiment is non-restrictive. The technical scope of the present disclosure includes all modifications within the meaning and scope equivalent to the description in the claims. For example, extracting optional configurations from the present embodiment and making optional combinations thereof is originally planned.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an exemplary expansion behavior of Si grains;

FIG. 2 is a conceptual diagram illustrating an example of a battery system according to the present embodiment;

FIG. 3 is a conceptual diagram illustrating an example of a pressurizing apparatus according to the present embodiment;

FIG. 4 is a conceptual diagram illustrating an exemplary all-solid-state battery according to the present embodiment; and

FIG. 5 is a schematic flowchart of a contact recovery process according to the present embodiment.

### DETAILED DESCRIPTION OF EMBODIMENTS

### Explanation of Terms

In the “clathrate II crystalline phase”, Si atoms form polyhedra. Each face of the polyhedron is pentagonal or hexagonal. Si atoms are placed at the vertices of the polyhedron. The polyhedron has a void that can contain guests (e.g., Li ions, etc.). In the “diamond-type crystalline phase”, Si atoms form tetrahedra. Si atoms are located at respective vertices and centers of gravity of the tetrahedron. It is believed that the tetrahedra do not have voids that can encompass the guest.

“SOC” indicates the percentage of the current object's charge capacity relative to the object's full charge capacity. The object may be, for example, Si grains (active materials), batteries, etc.

Descriptions of “comprising”, “including”, “having”, and variations thereof (e.g., “consisting of”, etc.) are open-ended terms. The open-end term may or may not further include additional elements in addition to the essential elements. The expression “consisting of” is a closed term. However, closed terms do not exclude additional elements that are commonly associated impurities or are unrelated to the disclosed technology. The phrase “consisting essentially of . . . ” is the term semi-closed. In the term semi-closed, the addition of elements that do not substantially affect the basic and novel properties of the disclosed technology is permitted.

Unless otherwise specified, the execution order of a plurality of steps, operations, operations, and the like included in various methods is not limited to the description order. For example, multiple steps may proceed simultaneously. For example, multiple steps may occur one after the other.

Elements expressed in the singular include the plural unless otherwise specified. For example, “particle” includes not only “one particle” but also “a plurality of particles (particle group)” and “aggregate of particles (powder, powder)”.

Numerical ranges such as “m to n %” include upper and lower limits, unless otherwise specified. That is, “m to n %” indicates a numerical range of “m % or more and n % or less”. Moreover, “m % or more and n % or less” includes “more than m % and less than n %”.

“At least one of A and B” includes “A or B” and “A and B”. “At least one of A and B” may also be written as “A and/or B”.

A “processor” is not limited to one that executes processing using a stored program method. A “processor” includes, for example, a hard-wired circuit such as an Application Specific Integrated Circuit (ASIC) or a Field-Programmable Gate Array (FPGA). The term “processor” may be understood to refer to a processing circuitry whose processing is predefined by means of computer readable code and/or hardwired circuitry.

### Battery System

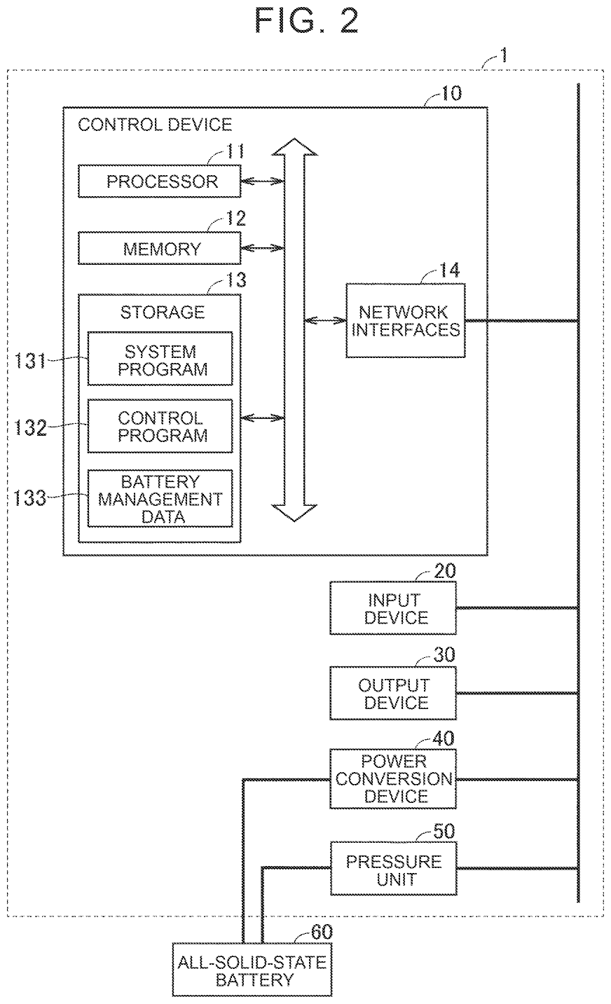

FIG. 2 is a conceptual diagram showing an example of the battery system in this embodiment. Hereinafter, “the battery system in this embodiment” may be abbreviated as “this system”.

The system 1 may be operated on-board, for example. For example, the system 1 may be mounted on an electrified vehicle or the like. For example, when the system 1 runs on board, the system 1 may include an all-solid-state battery 60.

The system 1 may, for example, be operated off-board. The system 1 may be installed, for example, in a processing facility (such as a recycling factory) of a used battery. For example, when the system 1 operates off-board, the all-solid-state battery 60 may be separate and independent from the system 1. In the present specification, as an example, a mode of operating on an off-board is described.

The system 1 includes a control device 10. The system 1 may further include, for example, an input device 20, an output device 30, a power conversion device 40, and a pressurizing device 50. Each element in the system 1 may be connected to each other by, for example, a communication bus or the like.

The control device 10 performs a “contact recovery process (to be described later)” on the all-solid-state battery 60 by controlling the power conversion device 40 and the pressurizing device 50. The control device 10 may include, for example, a processor 11, a memory 12, a storage 13, a network interface 14, and the like.

The storage 13 may include, for example, a nonvolatile memory. The nonvolatile memory may be rewritable. The storage 13 may include, for example, Hard Disk Drive (HDD), Solid State Drive (SSD), and the like. The storage 13 may store, for example, a system program 131, a control program 132, and battery management data 133. The system program 131 may include, for example, Operating System (OS). The control program 132 may include, for example, computer-readable code necessary for the control operation. The battery management data 133 may store, for example, various parameters for managing the all-solid-state battery 60.

The memory 12 may include, for example, a volatile memory. The memory 12 may include, for example, Random Access Memory (RAM).

The control device 10 may include one or more processors 11. That is, in the control device 10, the processor 11 may be any one or a plurality of processors. The processor 11 may include, for example, a microprocessor. The processor 11 may include, for example, Central Processing Unit (CPU), Micro-Processing Unit (MPU), and the like. The processor 11 reads the system program 131 and the control program 132. When the system program 131 and the control program 132 are loaded into the memory 12, various kinds of processing can be executed. The processor 11 may manage the all-solid-state battery 60, for example, by using the battery management data 133.

The network interface 14 may control communication between the control device 10 and other devices, for example. The communication between the apparatuses may include, for example, transmission and reception of a control command.

The input device 20 receives an input operation of an operator. The input device 20 may include, for example, a switch, a keyboard, a mouse, and the like. The output device 30 outputs various kinds of information (e.g., processing results) to the operator. The output device 30 may include, for example, a display.

The power conversion device 40 connects the all-solid-state battery 60 and an electric load (not shown). In accordance with a control command from the control device 10, the power conversion device 40 discharges the amount of electricity charged in the all-solid-state battery 60 to an electric load.

The pressurizing device 50 pressurizes the all-solid-state battery 60. In accordance with a control command from the control device 10, the pressurizing device 50 adjusts the pressure applied to the all-solid-state battery 60.

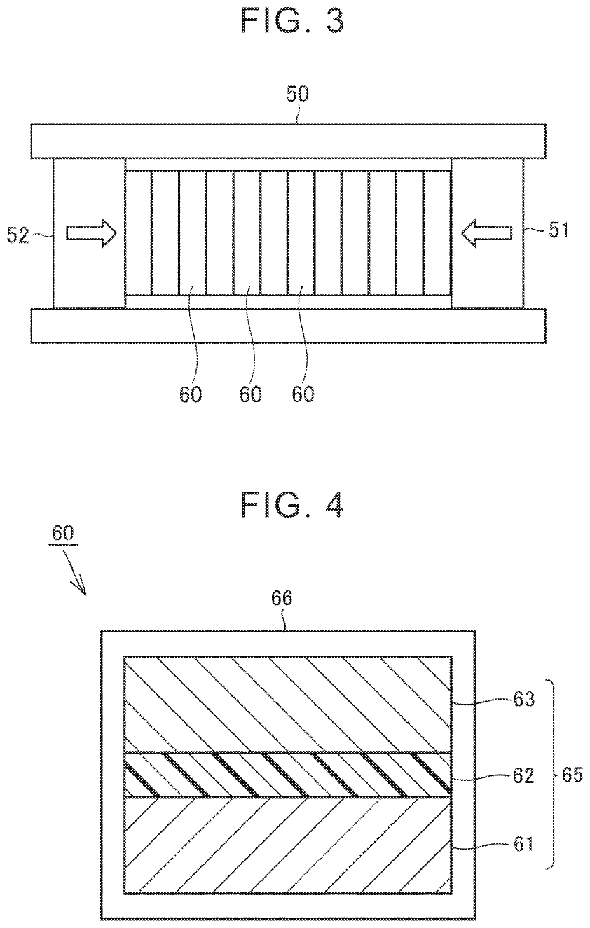

FIG. 3 is a conceptual diagram illustrating an example of a pressurizing apparatus according to the present embodiment. The pressurizing device 50 may include, for example, a first pressurizing plate 51 and a second pressurizing plate 52. The all-solid-state battery 60 is sandwiched between the first pressurizing plate 51 and the second pressurizing plate 52. The all-solid-state battery 60 may be any one or a plurality of all-solid-state batteries. For example, the pressurizing device 50 may adjust the positions of the first pressurizing plate 51 and the second pressurizing plate 52 in accordance with a control command from the control device 10. As the distance between the first pressurizing plate 51 and the second pressurizing plate 52 decreases, the pressure applied to the all-solid-state battery 60 may increase. The pressure applied to the all-solid-state battery 60 may also be referred to as, for example, a “constrained pressure”.

### All-Solid-State Battery

FIG. 4 is a conceptual diagram illustrating an example of an all-solid-state battery according to the present embodiment. The all-solid-state battery 60 includes a power generation element 65 and an exterior body 66. The exterior body 66 houses the power generation element 65. The exterior body 66 may have any form. The exterior body 66 may be, for example, a pouch made of a metal foil laminate film. The power generation element 65 includes an anode layer 61, a solid electrolyte layer 62, and a cathode layer 63 in this order. The power generation element 65 may have either a monopolar structure or a bipolar structure. The power generation element 65 may be any one or more. For example, a plurality of power generation elements 65 may be stacked in the thickness direction of the electrode layer.

The cathode layer 63 includes a cathode active material. The cathode active material includes Si grains. Si grains comprise a clathrate II crystalline phase. For example, the main phase of Si grains may be a clathrate II crystalline phase. For example, in X-Ray Diffraction (XRD) spectrum of Si grains, the clathrate II crystalline phase can be considered to be the main phase when the diffractive strength of the peak attributed to the clathrate II crystalline phase is the largest in all peaks. Si grains may further include another crystalline phase or the like as long as the clathrate II crystalline phase is included. Si grains may include a diamond-type crystalline phase, a clathrate I crystalline phase, and a clathrate II crystalline phase. Si grains may comprise, for example, from 0 to 30% of the diamond-type crystalline phase, from 0 to 30% of the clathrate I crystalline phase, and the balance of the clathrate II crystalline phase and inevitable impurities in molar fraction. Si grains may comprise, for example, from 0 to 10% of a diamond-type crystalline phase, from 0 to 10% of a clathrate I crystalline phase, and the remainder of the clathrate II crystalline phase and inevitable impurities in molar fractions. The molar fraction of the clathrate II crystalline phase may be, for example, 40% or more, 50% or more, 60% or more, 70% or more, 80% or more, 90% or more, or 95% or more. Si grains may, for example, consist essentially of a clathrate II crystalline phase. Si grains may comprise, for example, clathrate II crystalline phases and inevitable impurities.

XRD spectrum is measured by CuKα radiation. In XRD spectrum, for example, the peaks located at “2θ=20.09°, 21.00°, 26.51°, 31.72°, 36.26°, 53.01°” are considered to belong to the clathrate II crystalline phase. The peak position in the present specification may be in a range of ±0.50°, ±0.30°, or ±0.10°.

XRD spectrum of Si grains may satisfy, for example, the following equation:

1<I_{A}/I_{M}
I_{A}: 2θ=20.09°±0.50° maximum diffraction intensity (maximum peak height)
I_{M}: 2θ=22.50°±0.50° maximum diffraction intensity in the range
   When the intensity ratio “I_{A}/I_{M}” is greater than 1, it is considered that the presence ratio of the clathrate II crystalline phase is higher. The intensity ratio “I_{A}/I_{M}” may be, for example, 1.75 or more, or 1.80 or more. The intensity ratio “I_{A}/I_{M}” may be, for example, 2.00 or less, or 1.95 or less.

XRD spectrum of Si grains may satisfy, for example, the following equation:

1<I_{B}/I_{M}
I_{B}: 2θ=31.72°±0.50° maximum diffraction intensity in the range
   When the intensity ratio “I_{B}/I_{M}” is greater than 1, it is considered that the presence ratio of the clathrate II crystalline phase is higher. The intensity ratio “I_{B}/I_{M}” may be, for example, 1.35 or more, or 1.40 or more. The intensity ratio “I_{B}/I_{M}” may be, for example, 1.75 or less, or 1.70 or less.

In XRD spectrum, for example, the peaks located at “2θ=28.44°, 47.31°, 56.10°, 69.17°, 76.37°” are considered to belong to the diamond crystalline phase.

XRD spectrum of Si grains may satisfy, for example, the following equation:

1<I_{A}/I_{C}

1<I_{B}/I_{C}
I_{C}: 2θ=28.44°±0.50° maximum diffraction intensity in the range
   When at least one of the intensity ratios “I_{A}/I_{C}” and “I_{B}/I_{C}” is greater than 1, it is considered that the presence rate of the diamond crystal phase is low. At least one of the intensity ratios “I_{A}/I_{C}” and “I_{B}/I_{C}” may be, for example, 1.5 or more, 2 or more, or 3 or more.

In XRD spectrum, for example, a group of peaks located at “2θ=19.44°, 21.32°, 30.33°, 31.60°, 32.82°, 36.29°, 52.39°, 55.49°” is considered to belong to the clathrate I crystalline phase. XRD spectra of Si grains may not have peaks at these locations. In the absence of peaks at these positions, the presence of the clathrate I crystalline phase is considered to be low.

Si particles may form secondary particles. D50 of the secondary grains may be, for example, any of 0.1 to 100 μm, 1 to 50 μm, or 5 to 20 μm. “D50” refers to the particle size at which the integration is 50% in the volume-based particle size distribution (integrated distribution). The particle size distribution can be measured by laser diffraction methods. D50 is measured at a SOC of 0%.

In Si particles, the mean Feret's diameter of the primary particles may be, for example, any of 50 nm or more, 100 nm or more, or 150 nm or more. The mean Feret's diameter of the primary grains may be, for example, 3000 nm or less, 1500 nm or less, or 1000 nm or less. “Feret's diameter” is measured by microscopy. The Feret's diameter indicates the distance between the two farthest points on the contour of the particle. The average Feret's diameter represents an arithmetic mean of a Feret's diameter of 100 or more.

The primary particles have voids. The porosity of the primary particles is determined by the following formula.

ε=Vᵥ/(Vᵥ+Vₛ)
ε: Porosity (values are expressed as percentages).
Vᵥ: Area of the void portion in the cross-sectional image of the primary particle
Vₛ: Area of Si part in the cross-sectional image of the primary particle
   The cross-sectional images may be obtained, for example, by Scanning Electron Microscope (SEM). The cross-sectional sample of Si grains may be prepared, for example, by ion milling. For example, the image analysis software may calculate Vᵥ and Vₛ. The porosity may be, for example, either 4% or more or 10% or more. The porosity may be, for example, either 40% or less or 20% or less.

Si grains may have any pore distribution. The pore distribution can be measured by, for example, a mercury porosimeter, a gas adsorption amount measuring device, or the like. For example, the cumulative pore volume (hereinafter also referred to as “first void volume”) due to pores having pore diameters of 100 nm or less may be, for example, 0.05 cm³g⁻¹ or more, 0.07 cm³g⁻¹ or more, 0.10 cm³g⁻¹ or more, or 0.12 cm³g⁻¹ or more. The first void volume may be, for example, 0.25 cm³g⁻¹ or less, 0.24 cm³g⁻¹ or less, or 0.23 cm³g⁻¹ or less.

For example, the cumulative pore volume (hereinafter also referred to as “second void volume”) due to pores having a pore diameter of 50 nm or less may be, for example, 0.10 cm³g⁻¹ or more, 0.105 cm³g⁻¹ or more, or 0.11 cm³g⁻¹ or more. The second void volume may be, for example, 0.17 cm³g⁻¹ or less, 0.165 cm³g⁻¹ or less, or 0.16 cm³g⁻¹ or less.

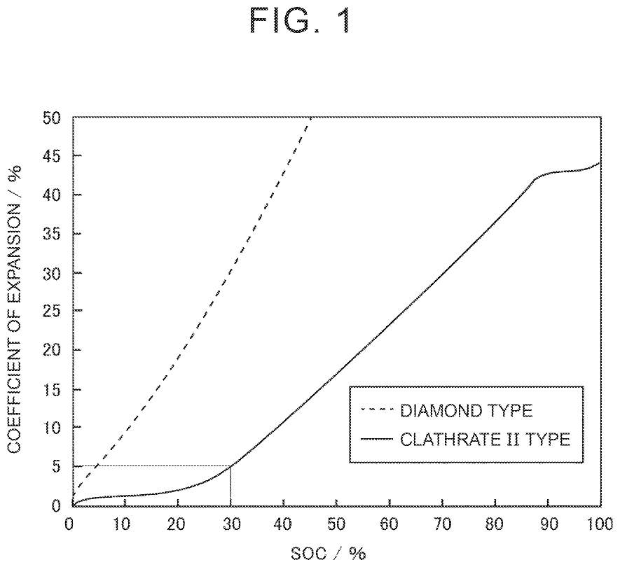

Si grains containing the clathrate II crystalline phase exhibit a unique expansion behavior (see FIG. 1). In SOC of 0 to 30%, there is a plateau in the curve. That is, in SOC of 0 to 30%, the slope of the tangent of the curve (the ratio of the increase in the coefficient of expansion to the increase in SOC) is very small. Hereinafter, the slope of the tangent of the curve is also simply referred to as “slope”. When SOC exceeds 30%, the slope tends to increase. In SOC of 0 to 30%, the slope may be, for example, 0.17 or less, or 0.10 or less. At SOC greater than 30%, the slope may be, for example, any of 0.2 or greater, 0.3 or greater, or 0.4 or greater. At SOC greater than 30%, the slope may be, for example, 0.6 or less.

Note that SOC range in which the plateau appears may vary depending on, for example, the amount of voids in Si grains. SOC range of 0 to 30% in FIG. 1 is merely an example. SOC extent at which the plateau appears can be, for example, 0 to 10%, 0 to 20%, or 0 to 40%, etc.

When the all-solid-state batteries 60 are in an over-discharge state, the coefficient of expansion of Si grains may be, for example, any of 5% or less, 3% or less, or 1% or less. When the all-solid-state batteries 60 are in normal use, the coefficient of expansion of Si grains may be, for example, any of more than 5%, 10% or more, 20% or more, or 30% or more. When the all-solid-state batteries 60 are in normal use, the coefficient of expansion of Si grains may be 50% or less, 40% or less, or 30% or less.

In addition to Si, Si grains may further contain components other than Si. Si grains may have, for example, the generic formula “NaₓSi₁₃₆”. In the general formula, for example, the relationship 0≤x≤20, 0≤x≤10, 0≤x≤5, or 0≤x≤1 may be satisfied.

The cathode layers 63 may further include another cathode active material as long as it contains Si grains. The cathode active material may include, for example, graphitic particles, SiO particles, and the like. The cathode layers 63 may further include other Si particles as long as the particles include Si particles including a clathrate II crystalline phase. The other Si grains may include, for example, a diamond-crystalline phase, a clathrate I crystalline phase, and the like.

The cathode layer 63 may further include a sulfide solid electrolyte in addition to the cathode active material. The amount of the sulfide solid electrolyte may be, for example, 1 to 200 parts by volume with respect to 100 parts by volume of the cathode active material. Sulfide solid electrolyte may be, for example, either glass-ceramics or argyrodite. For example, the sulfide solid electrolyte may include at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₂P₃S₁₁, Li₃PS₄, Li₂PS₆, and Li₆PS₅X (X═Cl, Br, I).

For example, “LiI—LiBr—Li₃PS₄” refers to a sulfide solid electrolyte produced by mixing LiI, LiBr and Li₃PS₄ in any molar ratio. For example, a sulfide solid electrolyte may be produced by a mechanochemical method. Mixing ratios may be specified by prefixing each raw material with a number. For example, “10LiI-15LiBr-75Li₃PS₄” indicates that the mixing ratio of the raw materials is “LiI/LiBr/Li₃PS₄=Oct. 15, 1975 (molar ratio)”.

The cathode layer 63 may further include, for example, a conductive material, a binder, and the like. The blending amount of the conductive material and the binder may be independently, for example, 0.1 to 10 parts by mass with respect to 100 parts by mass of the cathode active material. The conductive material may include, for example, vapor-grown carbon fibers, carbon black, carbon nanotubes, and the like. The binder may include, for example, polyvinylidene fluoride, styrene-butadiene rubber, and the like.

The anode layer 61 may include, for example, an anode active material, a sulfide solid electrolyte, a conductive material, a binder, and the like. The anode active material may include, for example, a lithium-containing transition metal oxide. The anode active material may include, for example, a LiNi_{1/3}Co_{1/3}Mn_{1/3}O₂.

The solid electrolyte layer 62 functions as a separator. The solid electrolyte layer 62 separates the anode layer 61 from the cathode layer 63. The solid electrolyte layer 62 may include, for example, a sulfide solid electrolyte and a binder.

### Contact Recovery Process

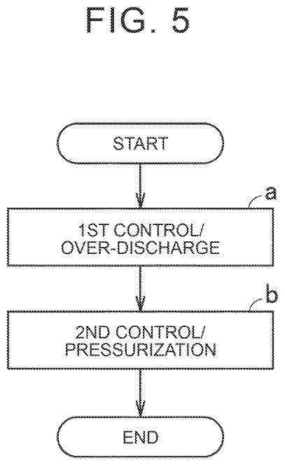

FIG. 5 is a schematic flowchart of a contact recovery process according to the present embodiment. The control device 10 executes a contact recovery process. The contact recovery process includes “(a) first control/over-discharge” and “(b) second control/pressurization”. Each operation may be realized by software processing incorporated in the control device 10. Each operation may be realized by hardware (electric circuit) arranged in the control device 10.

The processing target may be any one of a single all-solid-state battery 60 (cell) or a plurality of all-solid-state batteries 60 (cell module, assembled battery). The necessity of the contact recovery process may be determined in advance. For example, the control device 10 may determine whether or not the contact recovery process is necessary by referring to the battery management data 133 (use history, various electrical characteristics, and the like).

### (a) 1st Control/Over-Discharge

The first control includes placing the all-solid-state battery 60 in an over-discharge state. The control device 10 starts discharging the all-solid-state battery 60. For example, discharging may be started using an input operation of the operator to the input device 20 as a trigger.

The discharging is performed such that SOC of the all-solid-state batteries 60 is equal to or less than the set point. The set value may be a value smaller than SOC range during normal use. SOC in normal use may be, for example, any of 30 to 100%, 30 to 90%, or 30 to 80%. SOC of the all-solid-state battery may be adjusted to, for example, 30% or less, 20% or less, 10% or less, or 5% or less. In the over-discharge state, Si grains may have, for example, a SOC of from 0 to 30%. SOC of the batteries may or may not coincide with SOC of Si grains.

The first control may include performing at least one of constant voltage (CV) discharging and CV charging of the all-solid-state batteries 60 in the over-discharge state. For example, the all-solid-state batteries 60 may be placed in an over-discharge state by constant current constant voltage (CCCV) discharging. It is expected that Si grain size-variation is further reduced by maintaining a constant inter-terminal voltage in the over-discharge state. CV period (duration of CV discharging or CV charging) may be, for example, any of 1 hour or more, 4 hours or more, or 8 hours or more. CV period may be, for example, 24 hours or less, or 12 hours or less.

### (b) 2nd Control/Pressurization

The second control includes pressurizing the all-solid-state battery 60 in the over-discharge state. It is expected that the all-solid-state batteries 60 are pressurized in an over-discharge state (a state in which Si grains are uniform in size), thereby promoting the restoration of contacts in the cathode layers. The second control may be performed after the end of the first control. The second control may be performed simultaneously with the first control. For example, the all-solid-state batteries 60 during CV discharging may be pressurized.

The pressure may be applied, for example, along the thickness direction of the electrode layer. The magnitude of the pressure may be, for example, 1 to 50 MPa, 5 to 40 MPa, or 10 to 30 MPa. During pressurization, the magnitude of the pressure may be constant or may vary. The pressurization time may be, for example, any of 1 hour or more, 4 hours or more, or 8 hours or more. The pressurization time may be, for example, 24 hours or less, or 12 hours or less.

### ADDITIONAL REMARKS

The present disclosure also provides a vehicle (hereinafter also referred to as “the present vehicle”) including the present system. The vehicles may be, for example, electrified vehicle (EV), hybrid electric vehicle (HEV), or plug-in hybrid electric vehicle (PHEV).

In the present vehicle, the contact recovery process may be performed, for example, when the present vehicle is stopped for a long period of time. The contact recovery process may be performed, for example, at night. In the present vehicle, a restraint pressure may be applied to the all-solid-state battery during normal operation. The constraining pressure may be applied by any constraining jig, constraining device. The constraining pressure may be, for example, from 0.1 to 10 MPa. In the vehicle, the second control may include increasing the constraining pressure. The constraining pressure may be increased, for example, by a factor of 1.1 to 3. Of course, the system may be applied to any application other than a vehicle.

The present disclosure also provides a method of manufacturing an all-solid-state battery (hereinafter, also referred to as “the present manufacturing method”). The present manufacturing method can restore, for example, the capacity of an all-solid-state battery that has undergone capacity degradation. That is, the present manufacturing method can manufacture a regenerative battery. The present production method includes the following (a) and (b).
(a) The all-solid-state battery is placed in an over-discharge state.
(b) Pressurize the all-solid-state battery in the over-discharge state.
   The all-solid-state battery includes an anode layer, a solid electrolyte layer, and a cathode layer, in this order. The cathode layer includes silicon grains. The silicon grains include a clathrate II crystalline phase.

What is claimed is:

1. A battery system comprising a control device, wherein:
the control device is configured to perform a first control and a second control;
the first control includes placing an all-solid-state battery in an over-discharge state;
the second control includes pressurizing the all-solid-state battery in the over-discharge state;
the all-solid-state battery includes an anode layer, a solid electrolyte layer, and a cathode layer, in this order;
the cathode layer includes silicon grains; and
the silicon grains include a clathrate II crystalline phase.

2. The battery system according to claim 1, wherein, in the over-discharge state, the silicon grains of 0% to 30%.

3. The battery system according to claim 1, wherein the first control further includes performing at least one of constant voltage discharging and constant voltage charging of the all-solid-state battery in the over-discharge state.

4. The battery system according to claim 1, wherein the cathode layer further includes a sulfide solid electrolyte.

5. A battery system comprising a control device, wherein:
the control device is configured to perform a first control and a second control;
the first control includes placing an all-solid-state battery in an over-discharge state;
the first control further includes performing at least one of constant voltage discharge and constant voltage charging of the all-solid-state battery in the over-discharge state;
the second control includes pressurizing the all-solid-state battery in the over-discharge state;
the all-solid-state battery includes an anode layer, a solid electrolyte layer, and a cathode layer, in this order;
the cathode layer includes silicon grains and a sulfide solid electrolyte;
the silicon grains include a clathrate II crystalline phase; and
in the over-discharge state, the silicon grains are in a state of charge of 0% to 30%.
